(19) United States
(12) Patent Application Publication
(10) Pub. No.: US 2025/0285542 A1
(43) Pub. Date: Sep. 11, 2025

(54) DRIVING ASSISTANCE DEVICE, DRIVING ASSISTANCE METHOD, AND STORAGE MEDIUM STORING COMPUTER PROGRAM

(71) Applicant: TOYOTA JIDOSHA KABUSHIKI KAISHA, Aichi-ken (JP)

(72) Inventors: Takaya YAMASHITA, Nagoya-shi (JP); Hiroki SHIMAZU, Nisshin-shi (JP); Atsushi KATAOKA, Toyota-shi (JP); Yuki HATSUDE, Toyota-shi (JP)

(21) Appl. No.: 19/066,159

(22) Filed: Feb. 28, 2025

(30) Foreign Application Priority Data
Mar. 8, 2024 (JP) 2024-036382

(51) Int. Cl. G08G 1/16

(52) U.S. Cl. CPC G08G 1/166

(57) ABSTRACT

A driving assistance device for a vehicle is configured to at least issue a warning to the vehicle cabin when another vehicle around a host vehicle is in a driving assistance area that is set around the host vehicle and is on a side toward which the turn signal of the host vehicle is operated. The driving assistance device is also configured to suppress the warning when the other vehicle is estimated to leave the driving assistance area within a time required to turn right or left to the side toward which the turn signal is operated compared with when the other vehicle is estimated not to leave the driving assistance area when the speed of the host vehicle is equal to or higher than the speed of the other vehicle in the driving assistance area on the side toward which the turn signal of the host vehicle is operated.

### CROSS-REFERENCE TO RELATED APPLICATION

This application claims priority to Japanese Patent Application No. 2024-036382 filed on Mar. 8, 2024. The disclosure of the above-identified application, including the specification, drawings, and claims, is incorporated by reference herein in its entirety.

### BACKGROUND

### 1. Technical Field

The present disclosure relates to a driving assistance device, a driving assistance method, and a storage medium storing a computer program.

### 2. Description of Related Art

As a conventional surrounding monitoring device that monitors the driver's blind areas on the right and left sides of a host vehicle, Japanese Patent Application Publication No. 2008-129974 (JP 2008-129974 A) discloses a device that suppresses a warning about another vehicle that enters the blind area, leaves the blind area in a short time, and then moves into an area that the driver can directly see (for example, another vehicle that overtakes the host vehicle with a relatively large speed difference).

### SUMMARY

However, when the host vehicle turns right or left, the conventional surrounding monitoring device described above also suppresses a warning about another vehicle, such as a motorcycle, that is about to overtake the host vehicle on the side toward which the host vehicle is about to turn right or left. This may lead to a failure of preventing a contact accident (turn collision accident) with another vehicle that is traveling straight from behind when the host vehicle turns right or left. On the other hand, when the host vehicle turns right or left, some of the other vehicles present in the driving assistance area (blind area) of the host vehicle may detect that the host vehicle is about to turn right or left and is attempting to leave the driving assistance area. A warning about such vehicles, if issued to the driver, may make some drivers feel the warning annoying.

In view of the problems described above, it is an object of the present disclosure to appropriately issue a warning about another vehicle that is present in the driving assistance areas of a host vehicle when the host vehicle is about to turn right or left.

To solve the problems described above, a first aspect of the present disclosure relates to a driving assistance device for a vehicle. The driving assistance device is configured to at least issue a warning to the vehicle cabin when another vehicle around a host vehicle is present in a driving assistance area that is set around the host vehicle and is on a side toward which the turn signal of the host vehicle is operated. In addition, the driving assistance device is configured to suppress the warning when the other vehicle is estimated to leave the driving assistance area within a time required to turn right or left to the side toward which the turn signal is operated compared with when the other vehicle is estimated not to leave the driving assistance area when the speed of the host vehicle is equal to or higher than the speed of the other vehicle in the driving assistance area on the side toward which the turn signal of the host vehicle is operated.

A second aspect of the present disclosure relates to a driving assistance method for a vehicle. The driving assistance method includes at least issuing a warning to the vehicle cabin when another vehicle around a host vehicle is present in a driving assistance area that is set around the host vehicle and is on a side toward which the turn signal of the host vehicle is operated. In addition, the driving assistance method includes suppressing the warning when the other vehicle is estimated to leave the driving assistance area within a time required to turn right or left to the side toward which the turn signal is operated compared with when the other vehicle is estimated not to leave the driving assistance area when the speed of the host vehicle is equal to or higher than the speed of the other vehicle in the driving assistance area on the side toward which the turn signal of the host vehicle is operated.

A third aspect of the present disclosure relates to a storage medium storing a computer program. The computer program causes a computer to at least issue a warning to the vehicle cabin when another vehicle around a host vehicle is present in a driving assistance area that is set around the host vehicle and is on a side toward which the turn signal of the host vehicle is operated. In addition, the computer program causes the computer to suppress the warning when the other vehicle is estimated to leave the driving assistance area within a time required to turn right or left to the side toward which the turn signal is operated compared with when the other vehicle is estimated not to leave the driving assistance area when the speed of the host vehicle is equal to or higher than the speed of the other vehicle in the driving assistance area on the side toward which the turn signal of the host vehicle is operated.

According to the aspects of the present disclosure described above, a warning about another vehicle that is present in the driving assistance area of the host vehicle when the host vehicle is about to turn right or left can be issued appropriately. That is, a warning about another vehicle estimated not to leave the driving assistance area when the host vehicle turns right or left can be issued reliably, while a warning about another vehicle estimated to leave the driving assistance area when the host vehicle is about to turn right or left is suppressed. This can prevent the driver from feeling annoyed by the warning.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a driving assistance device according to one embodiment of the present disclosure;

FIG. 2 is a diagram showing an example of driving assistance areas that are set in advance around a host vehicle;

FIG. 3 is a diagram showing an example of a scene in which the host vehicle is about to turn left;

FIG. 4 is a flowchart showing driving assistance control according to one embodiment of the present disclosure; and

FIG. 5 is a diagram showing an example of a scene in which the host vehicle is about to turn left and showing a specific method for determining whether another vehicle is attempting to leave the driving assistance area of the host vehicle.

### DETAILED DESCRIPTION OF EMBODIMENTS

An embodiment of the present disclosure will be described in detail below with reference to the drawings. In the description below, similar components are given the same reference numerals.

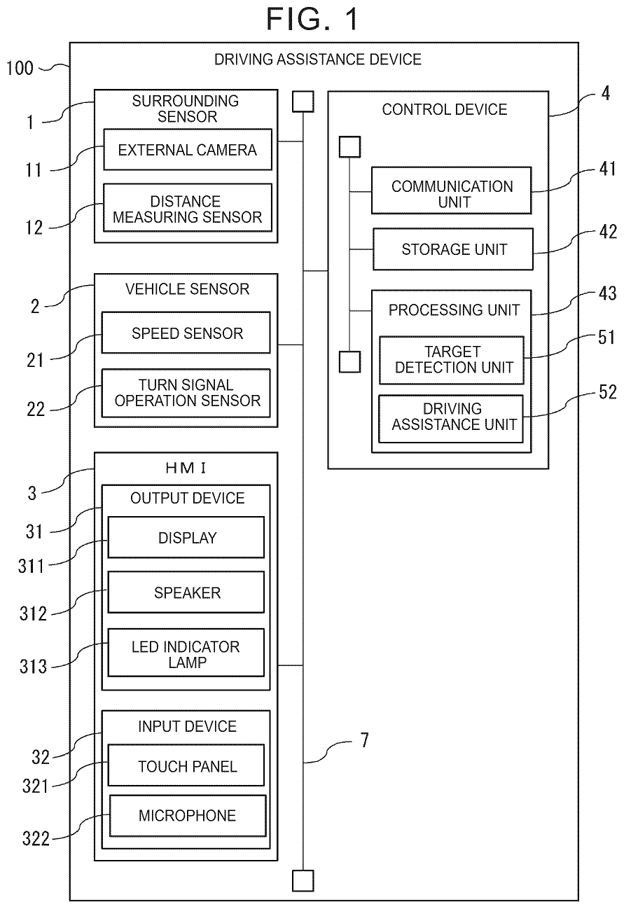

FIG. 1 is a schematic configuration diagram of a driving assistance device 100 according to one embodiment of the present disclosure.

The driving assistance device 100 includes a surrounding sensor 1, a vehicle sensor 2, a human machine interface (HMI) 3, and a control device 4. The surrounding sensor 1, vehicle sensor 2, HMI 3, and control device 4 are connected to each other so that they can communicate with each other via an in-vehicle network 7 that conforms to a standard such as a controller area network.

The surrounding sensor 1 is a sensor for generating surrounding data that represents the situation around a vehicle (hereinafter referred to as a “host vehicle”) that uses the driving assistance device 100 for driving assistance. In this embodiment, the surrounding sensor 1 includes one or more external cameras 11 that capture the surroundings of the host vehicle including the front of the host vehicle and one or more distance measuring sensors 12 that measure distances to various targets such as other vehicles (such as automobiles and motorcycles), pedestrians, and buildings around the host vehicle.

The external camera 11 captures the surroundings of the host vehicle at a predetermined frame rate (for example, 10 [Hz] to 40 [Hz]) and generates a surrounding image showing the surroundings of the host vehicle. Every time a surrounding image is generated, the external camera 11 sends the generated surrounding image to the control device 4 as surrounding data.

The distance measuring sensor 12 emits laser light, electric waves, or ultrasonic waves toward a distance measurement area around the host vehicle (front, sides, and rear) and receives the reflected light of the emitted laser light or the reflected waves of the emitted electric waves or the emitted ultrasonic waves. Then, based on the reflected light or reflected waves that are received, the distance measuring sensor 12 measures the distance to various targets that are present in the distance measurement area. The distance measuring sensor 12 sends distance measurement data, in which the distance to each target is associated with the coordinate information on each target, to the control device 4 as the surrounding data. Examples of the distance measuring sensor 12 include a Light Detection And Ranging (LiDAR) that emits radar light and measures the distance based on the reflected light, and a millimeter wave radar sensor that emits electric waves and measures the distance based on the reflected waves.

The vehicle sensor 2 is a sensor for generating vehicle data representing the situation of the host vehicle. In this embodiment, the vehicle sensor 2 includes a speed sensor 21 for generating speed data indicating the traveling speed of the host vehicle and a turn signal operation sensor 22 for generating the turn signal operation data indicating the operation state of the turn signal (blinker) of the host vehicle. However, the vehicle sensor 2 is not limited to these sensors. The vehicle sensor 2 sends each piece of acquired data to the control device 4 as the vehicle data.

The HMI 3 is a user interface for exchanging information between the host vehicle and its occupants. The HMI 3 includes an output device 31 that sends a notification to the vehicle occupants through the vehicle occupant's bodily senses (e.g., visual sense, acoustic sense, tactile sense, etc.) and an input device 32 that allows a vehicle occupant to perform input operations and response operations. In this embodiment, the HMI 3 includes a display (e.g., a meter display, a center display, a head-up display) 311, a speaker 312, and 15 an LED indicator lamp 313 as the output device 31, and a touch panel 321 and a microphone 322 as the input device 32.

The HMI 3 displays information (e.g., text information and image information) on the display 311 in response to a display signal received from the control device 4, and outputs voice from the speaker 312 in response to a voice signal. The HMI 3 also sends panel input data or voice input data (hereinafter referred to as “occupant input data”), input by a vehicle occupant via the input device 32, to the control device 4.

The HMI 3 may be a device pre-installed in the host vehicle or may be a terminal such as a vehicle occupant's smartphone. In the latter case, the information may be exchanged by carrying out short-range communication between the host vehicle and the vehicle occupant's terminal or the information may be exchanged indirectly via an external server (not shown) by carrying out communication between the vehicle occupant's terminal and the external server.

The control device 4 is an electronic control unit (ECU) including a communication unit 41, a storage unit 42, and a processing unit 43.

The communication unit 41 includes an interface circuit for connecting the control device 4 to the in-vehicle network 7. The communication unit 41 supplies various data, received from the sensors 1 and 2 and the HMI 3, to the processing unit 43. The communication unit 41 also outputs various signals, output from the processing unit 43, to the HMI 3, etc.

The memory unit 42 includes storage media such as a hard disk drive (HDD), a solid disk drive (SSD), and a semiconductor memory to store various computer programs, data, etc. for use by the processing of the processing unit 43.

The processing unit 43 includes one or more central processing units (CPUs) and their peripheral circuits to execute various computer programs stored in the storage unit 42. The processing unit 43 is, for example, a processor. The processing unit 43 may further include other arithmetic circuits such as a logic arithmetic unit, a numerical arithmetic unit, or a graphic processing unit. The processing unit 43 performs processing according to a computer program to function as a target detection unit 51 and a driving assistance unit 52, thus operating as functional units (modules) that implement predetermined functions. In the description below, when the processing is described with each of the functional units 51 to 52 as the subject, it is indicated that the processing unit 43 executes the program that implements each of the functional units 51 to 52.

The following describes the details of specific processing performed by the control device 4. That is, the following describes the details of each of the functional units 51 and 52 that is implemented when the processing unit 43 performs processing according to the program.

The target detection unit 51 detects another vehicle that is present around the host vehicle based on the surrounding data received from the surrounding sensor 1. For example, by grouping reflection points that are included in a plurality of reflection points detected by the distance measuring sensor 12 and that satisfy a predetermined condition as the reflection points of light, such as laser light, reflected from the same object, the target detection unit 51 can detect another vehicle that is present around the host vehicle. After that, the target detection unit 51 calculates the position and speed of the other vehicle by tracking the detected other vehicle on a time-series basis. The target detection unit 51 can also detect another vehicle, for example, by inputting a surrounding image, received from the external camera 11, into a classifier (e.g., convolutional neural network (CNN)) that has been trained in advance to detect another vehicle. Note that the method of detecting another vehicle is not limited to the methods described above and that various known methods may be used to detect another vehicle.

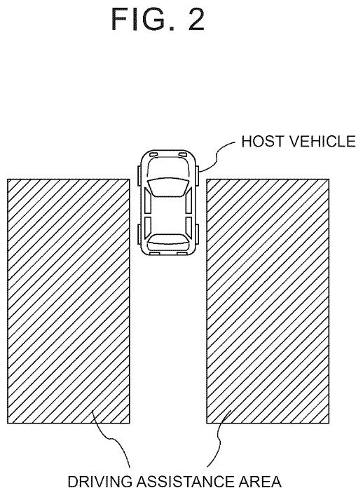

The driving assistance unit 52 performs driving assistance for the driver as follows. That is, when another vehicle recognized by the target detection unit 51 is present in the driving assistance area (see FIG. 2) that is preset around the host vehicle and, in addition, a predetermined condition is satisfied, the driving assistance unit 52 issues a warning, via the HMI 3, to inform that the other vehicle is present in the driving assistance area. The method of issuing a warning is not particularly limited. For example, the driving assistance unit 52 may issue a warning by turning on or blinking the LED indicator lamp 313, a warning by a message, a warning by a voice, or a bodily warning by vibrating the steering wheel.

The driving assistance performed by the driving assistance unit 52 will be described in more detail below with reference to FIG. 2 to FIG. 5.

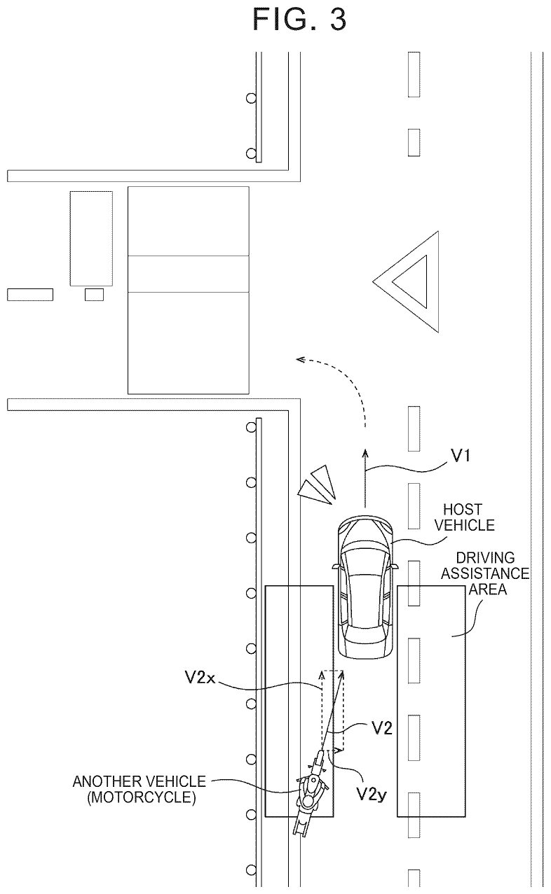

FIG. 2 is a diagram showing an example of driving assistance areas that are set in advance around the host vehicle. FIG. 3 is a diagram showing an example of a scene in which the host vehicle is about to turn left.

As shown in FIG. 2, the driving assistance area is an area on the right and left sides of, and behind, the host vehicle that is difficult for the driver to see directly.

For example, it is assumed that, in a scene in which the host vehicle is about to turn left, another moving vehicle such as a motorcycle may be present in the driving assistance area on the left side of the host vehicle as shown in FIG. 3.

In such a case, when the speed difference Vd(=V1−V2x) between the traveling speed V1 of the host vehicle and the speed component V2x of the traveling speed V2 of the other vehicle corresponding to the traveling direction of the host vehicle is smaller than zero, that is, when the other vehicle is faster than the host vehicle and the inter-vehicle distance between the host vehicle and the other vehicle decreases over time, the other vehicle may not detect that the host vehicle is about to turn left. Therefore, when the speed difference Vd between the host vehicle and the other vehicle is smaller than zero, there is a high probability of an accident that the host vehicle that is about to turn left will come into contact with the other vehicle traveling straight from behind (hereinafter referred to as a “turn collision accident”). It is therefore desirable to issue a warning to inform the driver that the other vehicle is present in the driving assistance area.

On the other hand, when the speed difference Vd between the host vehicle and the other vehicle is equal to or larger than zero, the inter-vehicle distance between the host vehicle and the other vehicle increases over time or the inter-vehicle distance between the host vehicle and the other vehicle is maintained. In this case, too, though the other vehicle may not detect that the host vehicle is about to turn left, it is also quite possible that the other vehicle detects that the host vehicle is about to turn left and, to avoid a collision (turn collision accident) with the host vehicle, moves to the right and adjusts its speed.

A warning about another vehicle that is attempting to leave the driving assistance area of the host vehicle, if issued to the driver as described above, may give annoyance to the driver. Therefore, for another vehicle that is attempting to leave the driving assistance area of the host vehicle, it is desirable to suppress the warning either by not issuing a warning or by lowering the warning level.

To address this problem, when another vehicle is present in the driving assistance area on the side toward which the host vehicle is about to turn right or left and when the speed difference Vd between the host vehicle and the other vehicle is equal to or larger than zero, this embodiment determines whether the other vehicle is attempting to leave the driving assistance area of the host vehicle and, depending on the determination result, suppresses the warning.

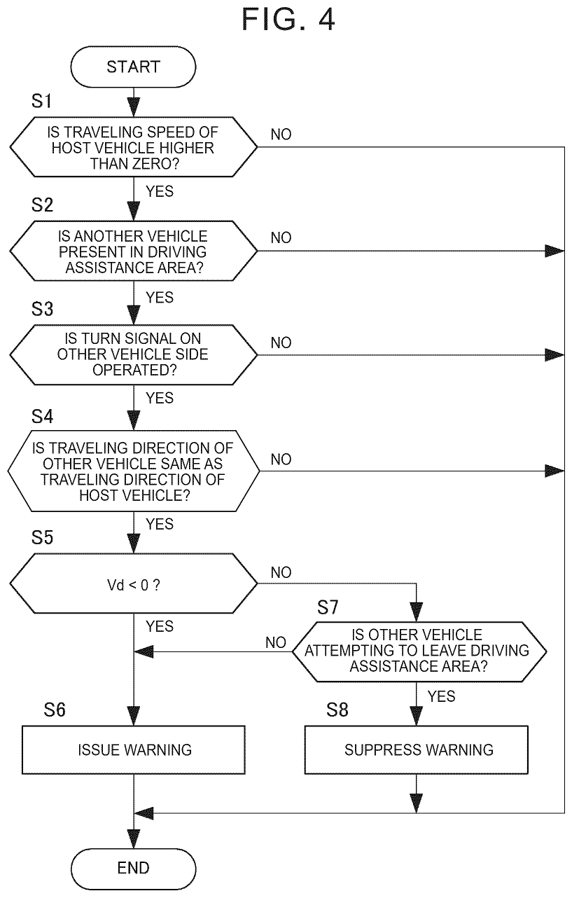

FIG. 4 is a flowchart showing the driving assistance control according to this embodiment performed by the driving assistance unit 52 or, in an even broader sense, by the control device 4. The control device 4 repeatedly executes this routine at a predetermined calculation period ΔT.

In step S1, the control device 4 determines whether the host vehicle is at a standstill. Whether the host vehicle is at a standstill can be determined, for example, based on the traveling speed of the host vehicle. In this embodiment, the control device 4 determines that the host vehicle is not at a standstill when the traveling speed of the host vehicle is higher than a predetermined threshold value (for example, 0 [m/s]). When the host vehicle is not at a standstill, the processing of the control device 4 proceeds to step S2. On the other hand, when the host vehicle is at a standstill, the control device 4 ends the current processing since, even if another vehicle is present in the driving assistance area, there is no risk of contact with the other vehicle in question due to the host vehicle.

In step S2, the control device 4 determines whether another vehicle is present in the driving assistance area. When another vehicle is present in the driving assistance area, the processing of the control device 4 proceeds to step S3. On the other hand, when no other vehicle is present in the driving assistance area, the control device 4 ends the current processing.

In step S3, the control device 4 determines whether the turn signal on the side on which the other vehicle is present in the driving assistance area is operated, based on the turn signal operation data. When the turn signal on the side on which the other vehicle is present in the driving assistance area is operated, the processing of the control device 4 proceeds to step S4. On the other hand, when the turn signal on the side on which the other vehicle is present is not operated, the control device 4 ends the current processing since there is no possibility of turn collision accident.

In step S4, the control device 4 determines whether the traveling direction of the other vehicle is the same as the traveling direction of the host vehicle. When the traveling direction of the other vehicle is the same as the traveling direction of the host vehicle, the processing of the control device 4 proceeds to step S5. On the other hand, when the traveling direction of the other vehicle is opposite to the traveling direction of the host vehicle, the control device 4 ends the current processing since there is no possibility of turn collision accident.

In step S5, the control device 4 determines whether the speed difference Vd (=V1−V2x) between the host vehicle and the other vehicle is smaller than zero, that is, whether the other vehicle is faster than the host vehicle and the inter-vehicle distance between the host vehicle and the other vehicle decreases over time. When the speed difference Vd(=V1−V2x) between the host vehicle and the other vehicle is smaller than zero, the processing of the control device 4 proceeds to step S6. On the other hand, when the speed difference Vd(=V1−V2x) between the host vehicle and the other vehicle is equal to or larger than zero, that is, when the inter-vehicle distance between the host vehicle and the other vehicle increases, or is maintained, over time, the processing of the control device 4 proceeds to step S7.

In step S6, since there is a high probability that the other vehicle has not detected that the host vehicle is about to turn left, the control device 4 issues a warning, as described above, to inform the driver that the other vehicle is present in the driving assistance area.

In step S7, the control device 4 determines whether the other vehicle is attempting to leave the driving assistance area of the host vehicle. When the other vehicle is attempting to leave the driving assistance area of the host vehicle, the processing of the control device 4 proceeds to step S8. On the other hand, when the other vehicle is not attempting to leave the driving assistance area of the host vehicle, the processing of the control device 4 proceeds to step S6.

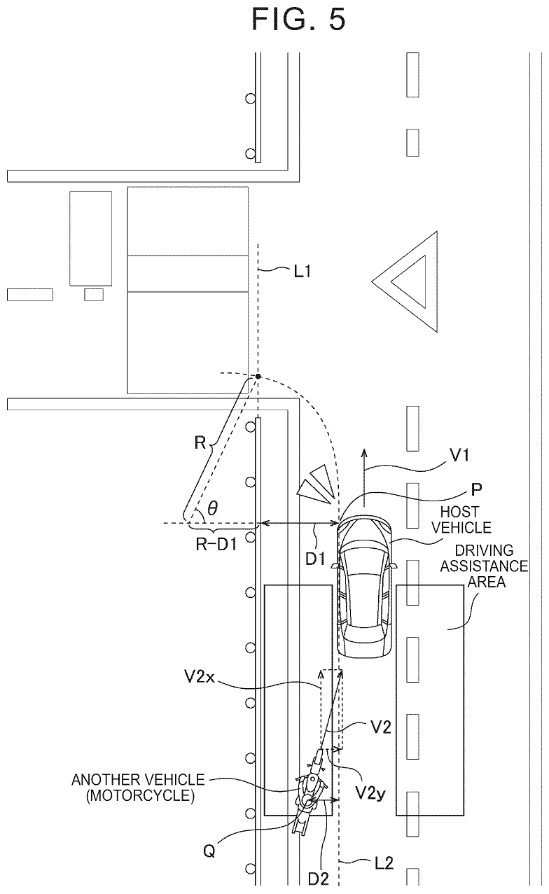

A specific method for determining whether another vehicle is attempting to leave the driving assistance area of the host vehicle will be described below with reference to FIG. 5. FIG. 5 is a diagram showing an example of a scene similar to that in FIG. 3, that is, a scene in which the host vehicle is about to turn left.

To determine whether the other vehicle is attempting to leave the driving assistance area of the host vehicle, the control device 4 first estimates the time T [s] required for the right or left turn operation to the side toward which the turn signal is operated. In this embodiment, the time T required for the right or left turn operation to the side toward which the turn signal is operated is the time required for the reference point P of the host vehicle to reach a virtual line L1 extending in the longitudinal direction of the road edge of the side toward which the turn signal is operated. In this embodiment, the position of the reference point P of the host vehicle is set to the left side corner part of the front end of the host vehicle when turning left, and to the right side corner part of the front end of the host vehicle when turning right. However, the position of the reference point P of the host vehicle is not limited to this position and may be, for example, the center of gravity of the host vehicle.

Therefore, in the example shown in FIG. 5, when the distance from the reference point P of the host vehicle to the road edge of the side toward which the turn signal is operated (the left side in the example of FIG. 5) is D1[m], the time until the distance D1 reaches zero is the time T required for the right or left turn operation to the side toward which the turn signal is operated (the time required for the host vehicle to turn left). When the radius of curvature of the road on which the vehicle is about to turn right or left is R[m], the time T can be calculated by formula (1) given below. Note that the radius of curvature R of the road can be acquired, for example, from the surrounding image received from the external camera 11 or from the map information that includes the information on the road.

$$\begin{matrix}Formula 1 & \\ T = 2 π R ( Θ / 360 ) / V 1 & ( 1 )\end{matrix}$$

$$where Θ [ deg ] = arccos ( ( R - D 1 ) / D 1 ) \times ( 180 / π )$$

When it is estimated that the other vehicle will cross a virtual line L2 extending from the reference point P of the host vehicle in the longitudinal direction of the driving lane (or parallel to the vehicle traveling direction) within the time T, the control device 4 determines that the other vehicle is attempting to leave the driving assistance area of the host vehicle. When the distance from the reference point Q of the other vehicle to the virtual line L2 is D2[m], it can be estimated that the other vehicle will cross the virtual line L2 within the time T, for example, when formula (2) given below is satisfied. The position of the reference point Q of the other vehicle, though set to the center of gravity of the other vehicle in this embodiment, is not limited to this position, as is the case for the reference point P of the host vehicle.

$$\begin{matrix}Formula 2 & \\ T > D 2 / V 2 y & ( 2 )\end{matrix}$$

In step S8, the control device 4 suppresses the warning by not issuing the warning informing the driver that another vehicle is present in the driving assistance area or by lowering the warning level of the warning, for example, below the warning level of the warning used in step S6. The warning level may be lowered in any way; for example, when the warning is issued by blinking the indicator in step S6, the warning can be issued by simply turning on the indicator. In addition, the warning level can be lowered, for example, by changing the voice message, volume, or vibration level.

The driving assistance device 100 for a vehicle according to the embodiment described above is configured to at least issue a warning to the vehicle cabin when another vehicle (predetermined target) around a host vehicle is present in a driving assistance area that is set around the host vehicle and is on the side toward which the turn signal of the host vehicle is operated. In addition, the driving assistance device 100 is configured to suppress the warning when the other vehicle is estimated to leave the driving assistance area within the time T required to turn right or left to the side toward which the turn signal is operated compared with when the other vehicle is estimated not to leave the driving assistance area when the traveling speed of the host vehicle is equal to or higher than the traveling speed of the other vehicle in the driving assistance area on the side toward which the turn signal of the host vehicle is operated.

In this embodiment, the time T required for the right or left turn operation to the side toward which the turn signal is operated is a time required for the reference point P of the host vehicle to reach the virtual line L1 extending in the longitudinal direction of the road edge of the side toward which the turn signal is operated. The driving assistance device 100 is configured to estimate that the other vehicle leaves the driving assistance area when the other vehicle crosses the virtual line L2 extending from the reference point P of the host vehicle in the longitudinal direction of the driving lane of the host vehicle within the time T.

The embodiment described above allows a warning to be appropriately issued about another vehicle that is present in the driving assistance area of the host vehicle when the host vehicle is about to turn right or left. That is, for another vehicle that is estimated not to leave the driving assistance area when the host vehicle turns right or left, a warning about the other vehicle is issued. On the other hand, for another vehicle that is estimated to leave the driving assistance area when the host vehicle turns right or left, a warning about the other vehicle is suppressed. Therefore, this configuration makes it possible to prevent the driver from feeling annoyed by the warning.

While the embodiment of the present disclosure has been described above, it is to be understood that the above embodiment merely illustrates a part of the application of the present disclosure and that it is not intended to limit the technical scope of the present disclosure to the specific configuration of the above embodiment.

For example, in the embodiment described above, the computer program executed by the control device 4 may be provided in a form recorded on a computer-readable portable recording medium, such as a semiconductor memory, a magnetic recording medium, or an optical recording medium.

What is claimed is:

1. A driving assistance device for a vehicle, the driving assistance device configured to:
at least issue a warning to a vehicle cabin when another vehicle around the vehicle is present in a driving assistance area that is set around the vehicle and is on a side toward which a turn signal of the vehicle is operated; and
suppress the warning when the other vehicle is estimated to leave the driving assistance area within a time required to turn right or left to the side toward which the turn signal is operated compared with when the other vehicle is estimated not to leave the driving assistance area when a speed of the vehicle is equal to or higher than a speed of the other vehicle in the driving assistance area on the side toward which the turn signal of the vehicle is operated.

2. The driving assistance device according to claim 1, wherein the time required to turn right or left to the side toward which the turn signal is operated is a time required for a reference point of the vehicle to reach a virtual line extending in a longitudinal direction of a road edge of the side toward which the turn signal is operated.

3. The driving assistance device according to claim 1, wherein the driving assistance device is configured to estimate that the other vehicle leaves the driving assistance area when the other vehicle crosses a virtual line extending from the reference point of the vehicle in a longitudinal direction of a driving lane of the vehicle within the time.

4. A driving assistance method for a vehicle, the driving assistance method comprising:
at least issuing a warning to a vehicle cabin when another vehicle around the vehicle is present in a driving assistance area that is set around the vehicle and is on a side toward which a turn signal of the vehicle is operated; and
suppressing the warning when the other vehicle is estimated to leave the driving assistance area within a time required to turn right or left to the side toward which the turn signal is operated compared with when the other vehicle is estimated not to leave the driving assistance area when a speed of the vehicle is equal to or higher than a speed of the other vehicle in the driving assistance area on the side toward which the turn signal of the vehicle is operated.

5. A non-transitory storage medium storing a computer program causing a computer to:
at least issue a warning to a vehicle cabin when another vehicle around a vehicle is present in a driving assistance area that is set around the vehicle and is on a side toward which a turn signal of the vehicle is operated; and
suppress the warning when the other vehicle is estimated to leave the driving assistance area within a time required to turn right or left to the side toward which the turn signal is operated compared with when the other vehicle is estimated not to leave the driving assistance area when a speed of the vehicle is equal to or higher than a speed of the other vehicle in the driving assistance area on the side toward which the turn signal of the vehicle is operated.
